(19) United States
(12) Patent Application Publication
(10) Pub. No.: US 2007/0115926 A1
(43) Pub. Date: May 24, 2007

(54) System and method for receiving a user message at a packet-network telephone

(75) Inventors: Taminder S. Chahal, Hoffman Estates, IL (US); Arun Singh, Fremont, CA (US); Pankaj Trehan, Naperville, IL (US); Vikas Vashisht, Naperville, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: 3COM Corporation, Marlborough, MA (US)

(21) Appl. No.: 11/260,785

(22) Filed: Oct. 27, 2005

(51) Int. Cl. H04L 12/66

(52) U.S. Cl. 370/352

(57) ABSTRACT

A system and method for receiving, at a packet-network telephone, a user message stored at a network device. Receiving the user message includes the packet-network telephone receiving a SIP message comprising an identifier that identifies (i) the user message, and (ii) a message transport protocol for retrieving the user message. The packet-network telephone transmits a request message addressed to the network device. The request message is arranged according to the message transport protocol and includes (i) at least a portion of the identifier so as to identify the user message, and (ii) a request for the user message to be transmitted to the packet-network telephone. The network device transmits the user message according to the message transport protocol. The packet-network telephone receives the user message, for presentation of the user message as the message is received or at a time subsequent to the packet-network telephone receiving the user message.

### BACKGROUND

1. Field of Invention

The present invention relates to message communication and, more particularly, to using packet-network telephones for receiving user messages stored at a network device.

2. Description of Related Art

Voice message systems allow a calling party to store (i.e., record) a voice message during a call placed to a given voice message system. A calling party may call the given voice message system directly or, alternatively, the calling party may call a called party. In the later case, if the called party does not answer or if the called party's telephone is in use, the call to the called party can be transferred to the voice message system.

After a calling party's call connects to the voice message system, a voice message from the calling party can be transmitted to the voice message system for storage at the voice message system. The voice message system stores the voice message for an identified called party. If a calling party's call is placed directly to the voice message system, the voice message system may prompt the calling party to identify a called party for whom the voice message is to be stored.

The voice message system can provide the called party with notice that a voice message has been stored for the called party at the voice message system. Typically, the called party's telephone turns on a light source (e.g., a light emitting diode (LED)) that functions as a message waiting indicator. A light source used as a message waiting indicator, however, does not provide any information associated with the message(s) that have been stored for the called party at the voice message system.

A called party can call a voice message system for any number of reasons, such as to listen to new voice messages that have been stored for the called party, to delete voice messages that the called party has already heard, and/or to perform administrative functions associated with a voice message account that is established at the voice message system. The called party may call a voice message system in response to noticing a message waiting indicator on the called party's telephone.

During a call placed by the called party to the voice message system, before the called party can access voice messages stored for the called party, the voice message system typically requires the called party to perform one or more access/identification functions. As an example, the voice message system may require the called party to identify himself/herself, such as by entering a telephone extension number assigned to the called party. As another example, the voice message system may require the called party to enter a password associated with the called party so as to verify that the called party should be allowed to access voice messages stored for the called party.

Moreover, during a call placed by the called party to the voice message system, after performance of the one or more access/identification functions but before the called party can access voice message messages stored for the called party, the voice message system typically requires the called party to perform one or more selection functions. As an example, the voice message system may require the called party to select whether to listen to messages, whether to create and send a message, or whether to perform administrative functions associated with the called party's voice message account (e.g., changing the called party's password). As another example, if the called party selects to listen to messages, the voice message system may require the called party to select whether to listen to new messages (messages that the called party has not yet accessed) or whether to listen to messages that the called party has accessed and saved.

The inventors have discovered that the current systems and methods for accessing stored messages are more burdensome than necessary. In particular, the inventors have discovered that the need for a called party to place a call to a voice message system, and then perform access/identification functions and selection functions, just to be able to have a stored message presented to the called party, is more burdensome than necessary, especially if the called party does not have any information about the stored message prior to placing the call to the voice message system.

### SUMMARY

The present invention advances over the existing art by providing an improved packet-network telephone for receiving a user message, and, a method for receiving a user message at a packet-network telephone.

An example embodiment of the present invention, in the form of a method comprises a method for receiving a user message at a packet-network telephone. According to the exemplary embodiment, the method includes: (i) receiving, at a packet-network telephone, a Session Initiation Protocol (SIP) message comprising an identifier that identifies a user message stored at a network device and a message transport protocol for retrieving the user message, and (ii) transmitting, from the packet-network telephone, according to the message transport protocol, a request message addressed to the network device. The request message comprises: at least a portion of the identifier so as to identify the user message, and a request for the user message to be transmitted to the packet-network telephone. The method also includes receiving the user message at the packet-network telephone. The user message is transmitted to the packet-network telephone according to the message transport protocol identified in the SIP message.

Another example embodiment of the present invention is a packet-network telephone for receiving a user message stored at a network device. The packet-network telephone comprises: (i) a processor, (ii) a network interface to transmit and receive messages, and (iii) data storage that stores computer-readable program instructions executable by the processor. The network interface receives a SIP message comprising an identifier. The identifier identifies a user message stored at a network device and a message transport protocol to retrieve the user message. The processor executes the program instructions to create a request message. The request message is addressed to the network device and is arranged according to the message transport protocol. The request message includes at least a portion of the user message identifier, so as to identify the user message, and a request for the user message to be transmitted to the packet-network telephone. The processor further executes the program instructions to instruct the network interface to transmit the request message. The network interface receives the user message, which is transmitted to the network interface according to the identified message transport protocol.

These as well as other aspects and advantages will become apparent to those of ordinary skill in the art by reading the following detailed description, with reference where appropriate to the accompanying drawings. Further, it should be understood that the embodiments described in this summary and elsewhere are intended to be examples only and do not necessarily limit the scope of the invention.

### BRIEF DESCRIPTION OF DRAWINGS

Exemplary embodiments of the invention are described herein with reference to the drawings, in which:

FIG. 1 is a simplified block diagram illustrating network architecture for use in carrying out the present invention in accordance with an exemplary embodiment;

FIG. 2 is a simplified block diagram depicting an exemplary packet-network telephone, and in particular, users interface of the exemplary packet-network telephone;

FIGS. 3 and 4 depict exemplary information that can be presented on a display of the exemplary packet-network telephone;

FIG. 5 depicts an exemplary message presentable on a display of the exemplary packet-network telephone;

FIG. 6 is a simplified block diagram depicting additional details of the exemplary packet-network telephone; and

FIG. 7 is a flow chart depicting functions that can be carried out in accordance with an exemplary embodiment.

### DETAILED DESCRIPTION

1. Exemplary Architecture

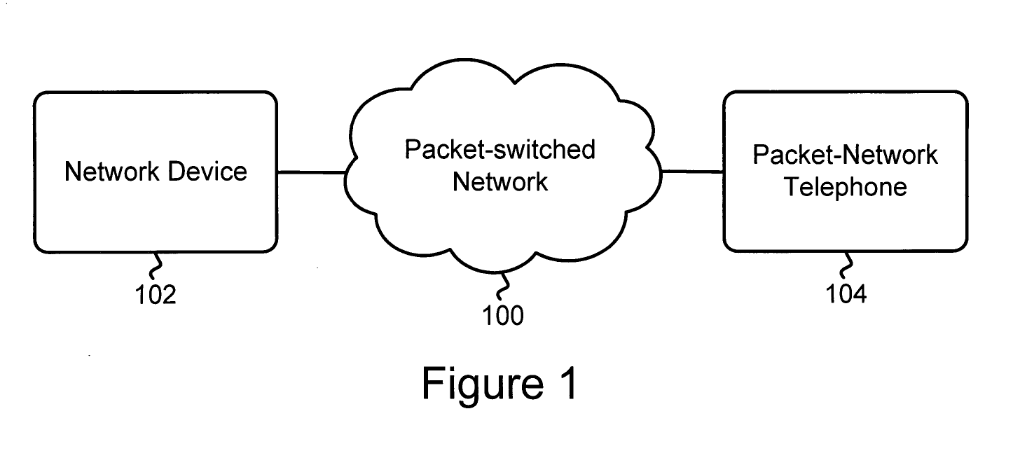

FIG. 1 depicts exemplary network architecture for use in carrying out the present invention. It should be understood, however, that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether. Further, many of the elements described herein are functional entities that may be implemented as discrete or distributed components or in conjunction with other components, in any suitable combination and location.

As shown in FIG. 1, a packet-switched network 100 is coupled to a network device 102 and to a packet-network telephone 104. The packet-switched network 100 transports data between a sending device (e.g., the network device 102) and a receiving device (e.g., the packet-network telephone 104). The data transmitted in the packet-switched network 100 is arranged in units of data called packets. One or more packets may define a message that is transmitted through the packet-switched network 100.

Each individual packet transmitted through the packet-switched network 100 does not necessarily travel along the same route within the packet-switched network 100. In this regard, the packet-switched network 100 does not contain a continuous or dedicated link between a sending device and a receiving device. Thus, the packet-switched network 100 differs from a circuit-switched network in that a circuit-switched network comprises a continuous and dedicated link, between a sending device and a receiving device, during a communication session.

As an example, the packet-switched network 100 may comprise a private Local Area Network (LAN), such as a LAN used by a business enterprise or a university. As another example, the packet-switched network 100 may comprise a Private Branch eXchange (PBX) telephone network. As yet another example, the packet-switched network 100 may comprise the Internet. Other examples of the packet-switched network 100, as well as other examples of devices that can be coupled to the packet-switched network 100, are also possible.

The network device 102 may comprise one or more serving devices (e.g., a server) to process various types of messages transmitted through the packet-switched network 100. Processing the various types of messages may comprise: (i) receiving messages transmitted to the network device 102 via the packet-switched network 100, and/or (ii) storing the received messages within data storage of the network device 102, and/or (iii) retrieving messages stored in data storage of the network device 102 and transmitting the retrieved messages to the packet-switched network 100 for transmission, in turn, to the packet-network telephone 104, and/or (iv) converting messages of a first type (e.g., e-mail messages) to messages of a second type (e.g., voice mail messages). Other examples of processing the various types of messages are also possible.

As an example, the network device 102 may comprise a unified message server that can process various types of user messages. User messages are messages that comprise message content for presentation to a user. Examples of the various types of user messages include (i) audible messages such as voice mail messages, or (ii) visual messages such as e-mail messages, facsimile messages, and short messaging service (SMS) messages, or (iii) audible/visual messages such as video-mail messages. Examples of the audible/visual messages may comprise messages stored as files having a “.wmv” (Windows Media Format) file extension or an “.mpeg” (Media Photographer Expert Group) file extension. Other examples of the messages that can be stored at the network device 102 are also possible.

The packet-network telephone 104 has the look, shape, and feel of a traditional telephone. Thus, the packet-switched telephone 104 differs from a soft-phone that is employed on a personal computer and that employs peripheral devices coupled to the personal computer. Examples of the packet-network telephone 104 include a 3COM® 3102 Business Phone, product number 3C1042A, and a 3COM® 3103 Manager Phone, product number 3C1043A, both manufactured by 3COM® Corporation, Marlborough, Mass., 01752-3064.

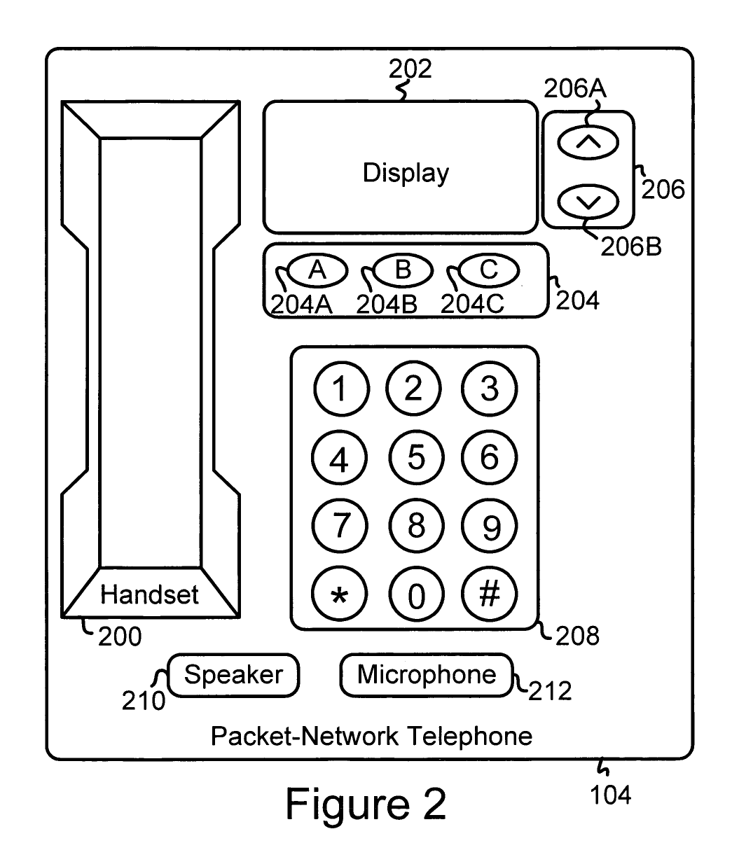

FIG. 2 illustrates details of the packet-network telephone 104. In particular, a user interface of the packet-network telephone 104 comprises a handset 200, a display 202, display-dependent buttons 204, fixed-function buttons 206, dialing buttons 208, a speaker 210, and a microphone 212.

The display-dependent buttons 204 comprise: (i) a first button 204A that is labeled “A,” (ii) a second button 204B that is labeled “B,” and (iii) a third button 204C that is labeled “C.” The display-dependent buttons 204 may comprise a number of buttons greater than or less than three buttons. Each of the display-dependent buttons 204A-C, when pressed, triggers the performance of a function associated with the pressed display-dependent button 204A-C. The function associated with each of the display-dependent buttons 204A-C can change to another function when the packet-network telephone 104 changes from a first operating mode to a second operating mode. The packet-network telephone 104 may change from the first operating mode to the second operating mode in response to the pressing of a display-dependent button 204A-C, a fixed-function button, or for any other of a variety of reasons.

The fixed-function buttons 206 comprise a fourth button 206A that is labeled [symbol] , and a fifth button 206B that is labeled [symbol] . Pressing the fourth button 206A triggers the performance of a “scroll up” function within the display 202. Pressing the fifth button 206B triggers the performance of a “scroll down” function within the display 202. The fixed-function buttons 206 may comprise a number of buttons greater than or less than two buttons. The function associated with each of the fixed-function buttons 206 does not change when the operating mode of the packet-network telephone 104 changes from a first operating mode to a second operating mode.

The handset 200 comprises a microphone. A microphone, such as the microphone within the handset 200, detects sound waves. This microphone can convert the detected sound waves into electrical signals. These electrical signals may, in turn, be converted to data packets that can be transmitted to a far-end device (e.g., another packet-network telephone) via the packet-switched network 100.

The handset 200 comprises a speaker for converting electrical signals into sound waves that a user of the packet-network telephone 104 can hear. The electrical signals may be based on packets transmitted from a far-end device via the packet-switched network 100. The packet-network telephone 104 also comprises the speaker 210 and the microphone 212 so that the packet-network telephone 104 can be operated in a hands-free mode (i.e., without using the handset 200). The hands-free mode allows a plurality of users (as well as a single user) to use the packet-network telephone 104 for performing communications with one or more far-end devices.

The display 202 may comprise one or more displays for displaying information at the packet-network telephone 104. The display 202 can comprise any of a variety of displays. For example, the display 202 can comprise a Liquid Crystal Display (LCD), and/or an Organic Light Emitting Diode (OLED) display. Other examples of the display 202 are also possible.

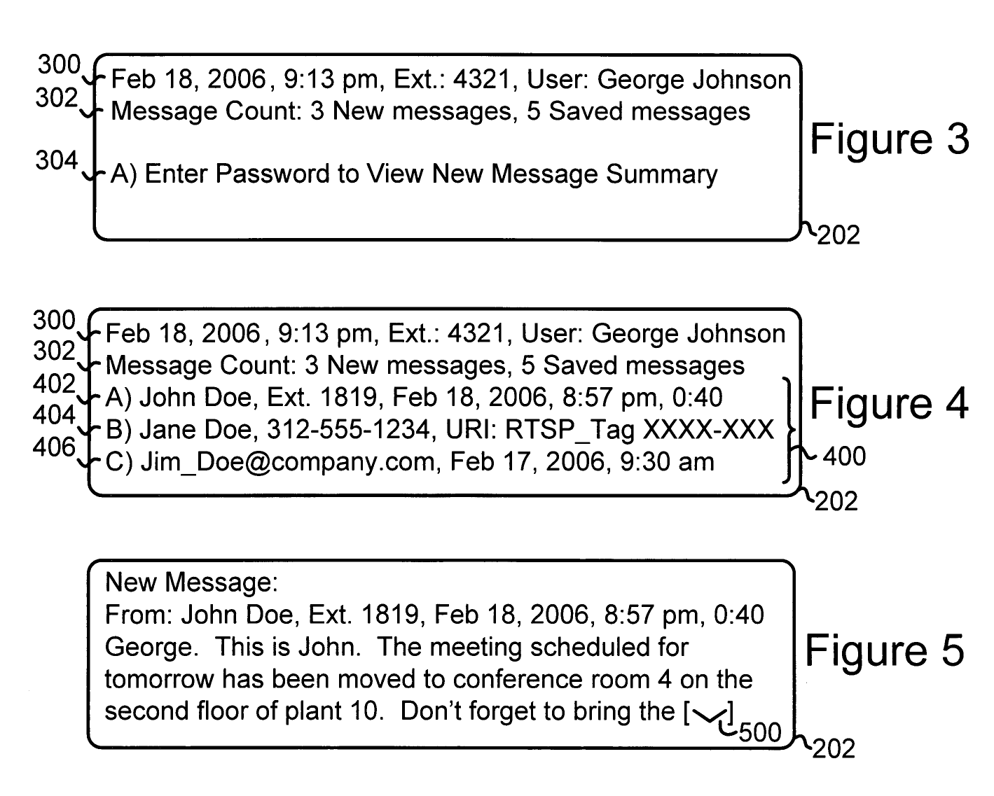

The display 202 can display a variety of information in various arrangements. FIGS. 3, 4, and 5, illustrate examples of particular arrangements for displaying a variety of information. As shown in FIG. 3, the display 202 can display time/user information 300 that includes (i) a current date (e.g., Feb. 18, 2006), (ii) a current time (e.g., 9:13 pm), (iii) a telephone extension assigned to the packet-network telephone 104 (e.g., Ext.: 4321), and (iv) a user name (e.g., George Johnson). The user name can indicate a user that is permanently assigned to the packet-network telephone 104. Alternatively, the user name can indicate a user that is temporarily assigned to the packet-network telephone 104. A user may be temporarily assigned to the packet-network telephone 104 after the user logs onto the packet-network telephone 104 and/or after the user logs onto the network device 102.

The display 202 can display a message count 302 that provides an indication of how many user messages are stored at the network device 102 for a particular user of the packet-network telephone 104. As shown in the figure, the message count 302, in conjunction with the time/user information 300, indicates that the user George Johnson has three (3) new messages and five (5) saved messages stored at the network device 102. New messages can comprise messages that have not yet been presented to the user to whom the messages are addressed. Saved messages can comprise messages that (i) have been presented to the user to whom the messages are addressed, and (ii) are stored on data storage of the network device 102. Other examples of new messages and/or saved messages are also possible.

The message count 302 may also provide other information about the messages stored at the network device 102. For example, the message count 302 may indicate the types of messages (e.g., e-mail messages and/or video-mail messages) and the quantity of each type of message stored at the network device 102.

The display 202 can display one or more user instructions. As an example, user instruction 304 is a user instruction identified as “Enter Password to View Message Summary.” Each user instruction displayed on the display 202 can be associated with a particular one of the display-dependent buttons 204A-204C. For example, the user instruction 304 is associated with the first button 204A. In this regard, a user can press the first button 204A and enter a password via the dialing buttons 208 so as to display a summary of messages that have been received for the user. Other examples of user instructions and other examples of the user instructions being associated with buttons of the packet-network telephone 104 are also possible.

FIG. 4 illustrates the time/user information 300, the message count 302, and a message summary 400 being displayed on the display 202. The message summary 400 comprises a first message listing 402, a second message listing 404, and a third message listing 406. Alternatively, the message summary 400 can comprise a number of message listings greater than or less than three message listings.

The first message listing 402 identifies information associated with a first user message. The first user message, stored at the network device 102, is from a person named John Doe and/or from a telephone having telephone extension number 1819. The telephone having extension number 1819 may comprise another packet-network telephone and may reside on a PBX network that includes the packet-network telephone 104. The first message listing 402 further indicates that the first user message was stored on Feb. 18, 2006 at 8:57 pm and that the duration of the first user message is (0:40) forty (40) seconds.

The second message listing 404 identifies information associated with a second user message. The second user message, stored at the network device 102, is from a person named Jane Doe and/or from a telephone identified by the telephone number 312-555-1234. The second user message listing 404 includes a Real-Time Streaming Protocol (RTSP) Uniform Resource Indicator (URI). An RTSP URI can uniquely identify a user message stored at the network device 102. In the second message listing 404, the RTSP URI is “URI: RTSP XXXXXXX”. The value XXXXXXX may include any combination of alpha-numeric characters and may comprise some number of alphanumeric characters that is greater than or less than seven alphanumeric characters. Other examples of an RTSP URI are also possible.

The third message listing 406 identifies information associated with a third user message. The third user message, stored at the network device 102, is from a person named Jim Doe who has an e-mail address of Jim_Doe@company.com.” The third user message was stored at the network device 102 on Feb. 17, 2006 at 9:30 am. The third user message may comprise an e-mail message. The third message listing 406 may include other information (not shown) about the third user message such as information that indicates: (i) the third user message includes an attached document, such as an Adobe Acrobat® PDF document, (ii) the number of words in the third user message, and/or (iii) a time that the sender created the third user message.

Each of the first message listing 402, the second message listing 404, and the third message listing 406, may display additional information associated with a particular user message stored at the network device 102. Such additional information may indicate that the particular user message is marked for deletion and/or that the particular user message may be converted from a first form (e.g., visual) to a second form (e.g., audible). Other examples of additional information that can be displayed in the first message listing 402, the second message listing 404, and the third message listing 406, are also possible.

The first message listing 402 is associated with the display-dependent button 204A. The second message listing 404 is associated with the display-dependent button 204B. The third message listing 406 is associated with the display-dependent button 204C. In this regard, a user can press any of the display dependent buttons 204A, 204B, or 204C (when the display 202 is displaying message listings as shown in FIG. 4), so as to cause the packet-network telephone 104 to present the message that is associated with the pressed display-dependent button.

Next, FIG. 5 depicts a portion of the first user message identified by the first message listing 402. The display 202 may display the portion of the first user message after a user presses the display dependent button 204A. In some cases, the display 202 may be able to display an entire user message at one time. The portion of a user message that the display 202 can display at any given time may depend on such factors as message length, font size, and size of the display 202. Other factors may also be partially determinative whether an entire user message can be displayed on the display 202.

For user messages that cannot be displayed on the display 202 in their entirety, a user can press the fourth button 206A (scroll-up) or the fifth button 206B (scroll-down) so as to cause the display 202 to present portions of the user message that are not being displayed at the time the fourth button 206A or the fifth button 206B is pressed. The symbol [symbol] 500 may be displayed to indicate that additional text is available by pressing the fifth button 206B “scroll down.” A symbol [symbol] (not shown) could be displayed to indicate that additional text is available by pressing the fourth button 206A “scroll up.”

Returning back to FIG. 2, the dialing buttons 108 include twelve dialing buttons. Alternatively, the dialing buttons 108 may include a number of buttons greater than or less than twelve buttons. A respective signal is produced when each of the dialing buttons 108 is pressed. The dialing buttons 108 provide means for entering telephone numbers and for entering other information such as a password. Each of the dialing buttons 108 is associated with a numeral 0-9 inclusive, a “#” symbol, or a “*” symbol. One or more of the dialing buttons 108 can also be associated with one or more letters of an alphabet for use in entering words. Depending on the operating mode of the packet-network telephone 104, the packet-network telephone 104 may interpret a respective signal produced upon the pressing a given dialing button to represent a numeral, a “#” symbol, a “*” symbol, a letter of an alphabet, or any other symbol or an instruction that may be associated with the given dialing button.

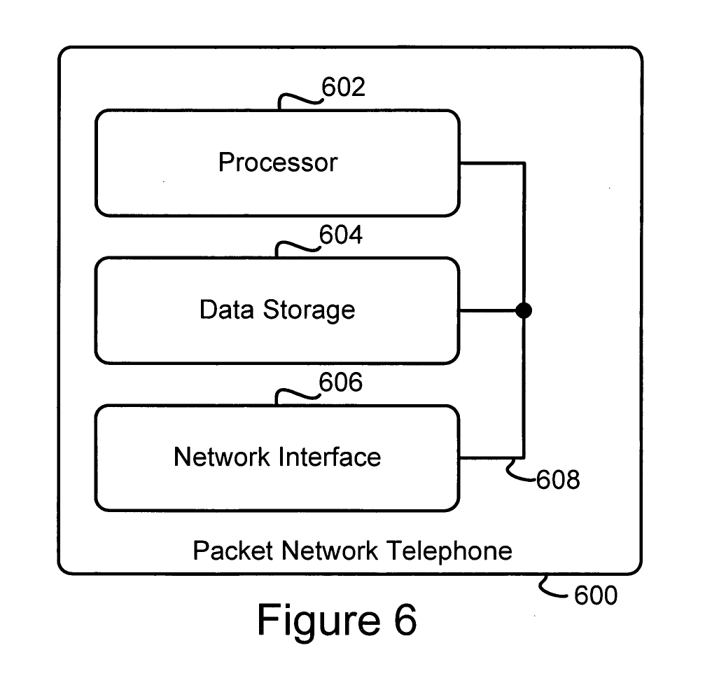

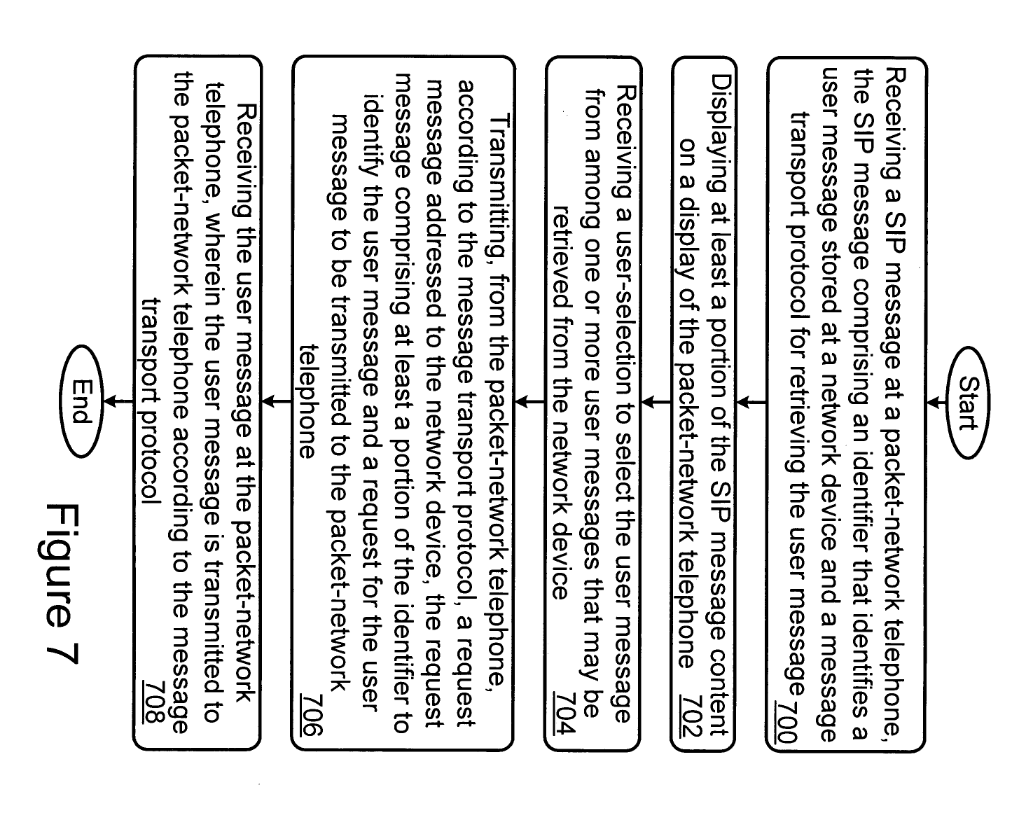

In FIG. 6, a packet-network telephone 600 is shown to comprise a processor 602, data storage 604, and a network interface 606, all linked together via a system bus, network, or other connection mechanism 608. The packet-network telephone 600 may be arranged as the packet-network telephone 104 described with respect to FIGS. 1 and 2.

The processor 602 may comprise one or more processors (e.g., a general purpose processor and/or a digital signal processor). The processor 602 provides means for executing computer-readable program instructions. By executing the program instructions, the processor 602 can work in cooperation with the user interface of the packet-network telephone 104, the data storage 604, and the network interface 606, so as to carry out the functions described herein.

The data storage 604 may comprise a computer-readable storage medium such as a magnetic disc, an optical disc, organic memory, and/or any other volatile or non-volatile mass storage system readable by the processor 602. Alternatively, the data storage 604 may comprise a combination of computer-readable storage media. For example, the data storage 604 may comprise a first computer-readable storage medium located within the processor 602 and a second computer-readable storage medium that is located remote from the processor 602. Other examples of computer-readable storage medium and other examples of computer-readable storage media combinations are also possible.

The data storage 604 provides means for storing computer-readable data. The data storage 604 may store computer-readable data arranged as program instructions that are executable by the processor 602. Execution of the program instructions cause the processor 602, alone or in combination with other devices of the packet-network telephone 600, to carryout functions described herein. As an example, the program instructions may comprise instructions that cause the processor 602 to display a particular user message in response to the processor 602 detecting a signal produced when one of the display-dependent buttons 204 is pressed. As another example, the program instructions may comprise instructions for detecting a SIP message has been received at the network interface 606, and, instructions for directing the network interface 606 to transmit the received SIP message to the processor 602. Other examples of computer-readable data storable at the data storage 604 and other examples of program instructions executable by the processor 602 are also possible.

The data storage 604 may store computer-readable data in the form of user messages. As an example, the data storage 604 may store a user message that has been retrieved from the network device 102. The data storage 604 may store the retrieved user message until the processor 602 executes program instructions to delete the user message from data storage 604.

The network interface 606 provides an interface to the packet-switched network 100. The network interface 606 may comprise a wired interface that physically couples the packet-network telephone 600 to the packet-switched network 100. For example, the network interface 606 may comprise a 10 Base-T/100 Base-T2/1000 Base-LX Ethernet interface that physically couples to the packet-switched network 100. In this regard, for example, the Ethernet interface may be arranged to comply with the Institute of Electrical and Electronics Engineers (IEEE) 802.3® standard for Carrier Sense Multiple Access with Collision Detection (CSMA/CD) Access Method.

Alternatively, or in combination, the network interface 606 may comprise a wireless air interface that interfaces to the packet-switched network 100 via a remote Ethernet interface that is (i) physically coupled to the packet-switched network 100, and (ii) arranged to comply with the IEEE 802.3 standard. As an example, the wireless air interface may be arranged to comply with an IEEE 802.11 standard. Other examples of the network interface 606 are also possible.

2. Example Operation

FIG. 7 is a flow chart provided to illustrate some of the functions that may be carried out with an example embodiment of a packet-network telephone for receiving user messages stored at the network device 102. Although the functions listed in FIG. 7 are shown in a sequence from top to bottom, the listed functions may be carried out according to a sequence that differs from the sequence shown in FIG. 7. Moreover, one or more of the listed functions shown in the figure may be omitted or modified so as to carry out an exemplary embodiment of the present invention.

As shown in FIG. 7, block 700 involves receiving a SIP message at a packet-network telephone. The SIP message may be sent to the packet-network telephone 104 via the packet-switched network 100. The SIP message may be sent to the packet-switched network 100 from the network device 102. The packet-network telephone 104 receives the SIP message at the packet-network interface 606.

The SIP message, received at the packet-network telephone 104, may be arranged as a SIP message as defined by a SIP standards document such as (i) the standards document entitled Request for Comments: 2543, SIP: Session Initiation Protocol, dated March 1999, and incorporated herein by reference, and/or (ii) the standards document entitled Request for Comments: 3265, Session Initiation Protocol (SIP)—Specific Event Notification, dated June 2002, and incorporated herein by reference. Examples of the SIP message include a SIP NOTIFY message or a SIP OPTIONS message. Other examples of the SIP message are also possible.

The SIP message, received at the packet-network telephone 104, comprises a user message identifier. The identifier identifies a user message stored at a network device and a message transport protocol for retrieving the user message stored at the network device. The identifier may be arranged in a variety of ways. For example, the identifier may comprise a URI to identify both a user message and a message transport protocol. The identifier may include any of a variety of URI.

As an example, the identifier may include an RTSP URI to identify a message transport protocol (i.e., RTSP) and to identify a particular user message stored at a network device. For instance, the RTSP URI may be arranged as “rtsp://user_message@network_device.net/message_number_{—}1234.” In this regard, “ftp” identifies the message transport protocol, and “message_number_{—}1234” identifies a particular user message stored at the network device. As another example, an RTSP URI may be arranged as “RTSP_Tag XXXX-XXX,” as shown in FIG. 4. Other examples of an RTSP URI are also possible.

As another example, the identifier may include a Hyper-Text Transfer Protocol (HTTP) URI to identify a message transfer protocol (i.e., HTTP) and to identify a particular user message stored at a network device. For instance, the HTTP URI may be arranged as “http://user_message@network_device.net/message_number_{—}1234.” In this regard, “http” identifies the message transport protocol, and “message_number_{—}1234” identifies a particular user message stored at the network device. Other examples of an HTTP URI to identify a message transport protocol and a particular user message are also possible.

As yet another example, the identifier may include a File Transport Protocol (FTP) URI to identify a message transport protocol (i.e., FTP) and to identify a particular user message stored at a network device. For instance, the FTP URI may be arranged as “ftp://ftp_user_message@network_device.net/message_number_{—}1234.” In this regard, “ftp” identifies the message transport protocol, and “message_number_{—}1234” identifies a particular user message stored at the network device. Other examples of an FTP URI to identify a message transport protocol and a particular user message are also possible.

As still yet another example, the identifier may include a SIP URI to identify a message transfer protocol (i.e., SIP) and to identify a particular user message stored at a network device. The SIP URI may take the form of sip://user_message@network_device.net/message_number_{—}1234. In this regard, “sip” identifies the message transport protocol and “message_number_{—}1234” identifies a particular message stored at the network device. The SIP URI may also identify the network device storing the user message (e.g., network_device.net). Other examples of a SIP URI are also possible.

The SIP message, received at the packet-network telephone 104, may include additional information within or in combination with the identifier. Examples of the additional information include (i) a name of a person that created the user message, (ii) a time that the user message was created, (iii) a time that the user message was stored at the network device, and (iv) a time duration of the user message.

In an alternative embodiment, the SIP message, received at the packet-network telephone, may include a plurality of identifiers to identify a plurality of user messages and a respective message transport protocol for retrieving each of the plurality of user messages.

Next, block 702 involves displaying at least a portion of the SIP message content (i.e., content of the SIP message) on a display of the packet-network telephone 104. Examples of the at least a portion of the SIP message content being displayed on the display 202 are shown in FIG. 3 and FIG. 4. Displaying the at least a portion of the SIP message content allows a user of the packet-network telephone 104 to see information about at least one user message stored at the network device 102. In this way, the user can make a selection as to which, if any, of the at least one user message the user would like to have transmitted to the packet-network telephone 104.

Next, block 704 involves receiving a user-selection to select the user message from among one or more user messages that may be retrieved from the network device. The user-selection is received via a user interface of the packet-network telephone 104. In this regard, the user-selection identifies a particular user message for which the packet-network telephone 104 should send a request message. The packet-network telephone 104 transmits the request message to the packet-switched network 100 for transmission, in turn, to the network device 102. The request message comprises a request for the network device 102 to transmit the particular user message, identified by the user-selection, to the packet-network telephone 104.

Receiving the user-selection may occur using any of a variety of methods. For example, receiving the user-selection may comprise the processor 602 detecting signals produced when a button of the packet-network telephone user interface is pressed. In this regard, the processor 602 may detect a signal produced when a given one of the display-dependent buttons 204A-204C is pressed. As described above with respect to FIG. 4, the first message listing 402 is associated with display-dependent button 204A, such that pressing the display-dependent button 204A produces a signal that indicates the user desires to have the message identified by the first message listing 402 presented at the packet-network telephone 104.

As another example, receiving the user-selection may comprise receiving a user-selection that is spoken into the speaker of the handset 200 or into the speaker 210. In this regard, the packet-network telephone 104 may comprise interactive voice response (IVR) processing capabilities for discerning the user-selection from the user's spoken words. Other examples of receiving the user-selection are also possible.

In response to receiving the user-selection, the processor 602 may execute program instructions to create a request message. The request message is addressed to the network device that stores the user message which is selected by the user-selection. The request message is arranged according to the message transport protocol identified in the user message identifier. For instance, if the identified message transport protocol is HTTP, then the request message is arranged as an HTTP message (e.g. an HTTP GET message).

In the example where the user message identifier includes an RTSP URI, the request message may comprise any one of a variety of RTSP messages. The RTSP message may be arranged according to an RTSP standards document such as Request for Comments: 2326, Real Time Streaming Protocol (RTSP), which is dated April 1998 and is hereby incorporated by reference. As an example, the request message arranged as (i) an RTSP DESCRIBE message, (ii) and RTSP ANNOUNCE message, (iii) an RTSP SETUP message, (iv) an RTSP PLAY message, (v) an RTSP OPTIONS message, (vi) an RTSP GET_PARAMETER message, or (vii) an RTSP SET_PARAMETER message. Other examples of the request message arranged as an RTSP message are also possible.

Moreover, the request message may include at least a portion of the user message identifier so as to identify the selected message. For instance, the request message may identify a selected message by including the term “message_number_{—}1234” from a URI. The request message may also include a request for the network device to transmit the user message to the packet-network telephone. The request to transmit the user message may be expressly included in the request message, such as a particular bit within the request message being encoded to represent a request to transmit a user message. Alternatively, the request to transmit the user message may be implied by transmission of the URI received in the SIP message. Other examples of arranging the request message are also possible.

Next, block 706 involves transmitting, from the packet-network telephone, a request message addressed to the network device. The processor 602 may execute program instructions that instruct the network interface to transmit the request message. The request message may be transmitted to the packet-switched network 100 for transmission, in turn, to the network device 104.

Transmitting the request message from the network interface 606 to the packet-switched network 100 may occur using various methods. For example, transmitting the request message from the network interface 606 may include broadcasting the request message over a wireless air interface, such as an 802.11 air interface. As another example, transmitting the request message from the network interface 606 may include transmitting the request message to a wired connection of the packet-switched network. Other examples of transmitting the request message are also possible.

Next, block 708 involves receiving the user message at the packet-network telephone, such as the packet-network telephone 600. The user message is transmitted to the packet-network telephone 600 according to the message transport protocol identified in the user message identifier. The user message may be transmitted to the packet-network telephone 600 from the network device 102 via the packet-switched network 100.

The user message may be received at the network interface 606 of the packet-network telephone 600. After the network interface 606 receives the user message (or while the network interface is receiving the user message), the network interface 606 may provide a signal to the processor 602 to indicate the user message has been received (or is being received). In response, the processor 602 may execute program instructions to carry out storing the user message at the data storage 604 and/or to present the user message at a user interface of the packet-network telephone 600. In the case where the user message is stored in the data storage 604, after the user message is stored, the processor 602 may execute program instructions to present the user message at the user interface of the packet-network telephone 600.

The processor 602 may also execute program instructions to carry out the functions of a converter that converts at least a portion of the user message in a first form (e.g., computer-readable data such as an encoded audio content or encoded visual content) to at least a portion of the user message in a second form (e.g., an audio signal that can be played by a speaker or a video signal that can be displayed by a display). After converting the at least a portion of the user message, the processor 602 may send the converted signal(s) to the appropriate user interface device (e.g., speaker or display) so as to present at least a portion of the user message at the user interface device of the packet-network telephone.

In the example where the message transport protocol is RTSP, the user message may be transmitted (e.g., streamed), from the network device 102 to the packet-network telephone 600, according to the RTSP protocol. The user message streamed to the packet-network telephone may be presented to a user of the packet-network telephone 600 as the user message is being received. Alternatively, the packet-network telephone 600 may present the user message to a user of the packet-network telephone 600 after the packet-network telephone 600 has received the entire user message. Presentation of the user message may be carried out by an RTSP-based media player of the packet-network telephone 600.

Other examples of presenting the user message to a user of the packet-network telephone, as well as other examples of what the packet-network telephone can do with a user message after the packet-network telephone receives the user message, are also possible.

3. Conclusion

Exemplary embodiments of the present invention have been described above. Those skilled in the art will understand, however, that changes and modifications may be made to the embodiments described without departing from the true scope and spirit of the present invention, which is defined by the claims.

We claim:

1. A method for receiving a user message at a packet-network telephone, the method comprising:
receiving, at a packet-network telephone, a Session Initiation Protocol (SIP) message comprising an identifier that identifies (i) a user message stored at a network device, and (ii) a message transport protocol for retrieving the user message;
transmitting, from the packet-network telephone, according to the message transport protocol, a request message addressed to the network device, wherein the request message comprises: (i) at least a portion of the identifier to identify the user message, and (ii) a request for the user message to be transmitted to the packet-network telephone; and
receiving the user message at the packet-network telephone, wherein the user message is transmitted to the packet-network telephone according to the message transport protocol.

2. The method of claim 1,
wherein the identifier comprises a Real-Time Streaming Protocol (RTSP) Uniform Resource Indicator (URI), and
wherein the identified message transport protocol is an RTSP.

3. The method of claim 2,
wherein the request message comprises a message selected from the group consisting of (i) an RTSP DESCRIBE message, (ii) an RTSP ANNOUNCE message, (iii) an RTSP SETUP message, (iv) an RTSP PLAY message, (v) an RTSP OPTIONS message, (vi) an RTSP GET_PARAMETER message, and (vii) an RTSP SET_PARAMETER message.

4. The method of claim 2, further comprising:
presenting the user message at a user interface of the packet-network telephone as the user message is being received at the packet-network telephone.

5. The method of claim 1,
wherein the identifier comprises a Hyper-Text Transfer Protocol (HTTP) Uniform Resource Indicator (URI), and
wherein the identified message transport protocol is an HTTP.

6. The method of claim 1,
wherein the identifier comprises a File Transfer Protocol (FTP) Uniform Resource Indicator (URI), and
wherein the identified message transport protocol is an FTP.

7. The method of claim 1,
wherein the identifier comprises a SIP Uniform Resource Indicator (URI), and
wherein the identified message transport protocol is an SIP.

8. The method of claim 1, wherein the SIP message comprises a SIP message selected from the group consisting of: (i) a SIP NOTIFY message, and (ii) a SIP OPTIONS message.

9. The method of claim 1,
wherein the SIP message further includes information selected from the group consisting of (i) a name of a person that created the user message, (ii) a time that the user message was stored, and (iii) a time duration of the user message, and
wherein the method further comprises displaying at least a portion of the information on a display of the packet-network telephone.

10. The method of claim 1, further comprising:
providing at least a portion of the user message received at the packet-network telephone to a converter of the packet-network telephone for converting audible content encoded within the user message to a signal that can be output by a speaker of the packet-network telephone; and
providing the signal to the speaker for presenting the audible content encoded within the user message.

11. The method of claim 1, further comprising:
providing at least a portion of the user message received at the packet-network telephone to a display device for displaying visual content encoded within the user message.

12. The method of claim 1, wherein the user message comprises a message selected from the group consisting of (i) a voice mail message, (ii) an e-mail message, (iii) a facsimile message, (iv) a short messaging service (SMS) message, and (v) a video mail message.

13. The method of claim 1,
wherein the request message is established in response to the packet-network telephone receiving a user-selection to select the user message from among one or more user messages that may be retrieved from the network device, and
wherein the user-selection is entered via a user interface of the packet-network telephone.

14. The method of claim 1, further comprising:
storing the user message at the packet-network telephone, and
thereafter presenting the user message at a user interface of the packet-network telephone.

15. A packet-network telephone for receiving a user message stored at a network device, the packet-network telephone comprising:
a processor;
a network interface to transmit messages and to receive messages; and
data storage for storing computer-readable program instructions executable by the processor,
wherein the network interface receives a Session Initiation Protocol (SIP) message comprising an identifier that identifies: (i) a user message stored at a network device, and (ii) a message transport protocol to retrieve the user message;
wherein the processor executes the program instructions to (i) create a request message addressed to the network device and arranged according to the message transport protocol, wherein the request message includes at least a portion of the identifier to identify the user message and includes a request for the user message to be transmitted to the packet-network telephone, and (ii) instruct the network interface to transmit the request message; and
wherein the network interface receives the user message as transmitted according to the identified message transport protocol.

16. The packet-network telephone of claim 15, further comprising:
a user interface for presenting the user message received at the network interface of the packet-network telephone.

17. The packet-network telephone of claim 16, wherein the user interface comprises:
a display for displaying visual content encoded within the user message; and
a speaker for presenting audible content encoded within the user message.

18. The packet-network telephone of claim 16,
wherein the message transport protocol comprises a Real-Time Streaming Protocol (RTSP), and
wherein the user interface comprises an RTSP-based media player for presenting the user message.

19. The method of claim 16,
wherein the processor executes the program instructions to store the user message in data storage prior to executing the program instructions to present the user message at the user interface.

20. The packet-network telephone of claim 15,
wherein the SIP message comprises a message selected from the group consisting of (i) a SIP NOTIFY message, and (ii) a SIP OPTIONS message.

21. The packet-network telephone of claim 15,
wherein the identifier comprises a Hyper-Text Transfer Protocol (HTTP) Uniform Resource Indicator (URI), and
wherein the identified message transport protocol is an HTTP.

22. The packet-network telephone of claim 15,
wherein the identifier comprises a File Transfer Protocol (FTP) Uniform Resource Indicator (URI), and
wherein the identified message transport protocol is an FTP.

23. The packet-network telephone of claim 15,
wherein the identifier comprises a SIP Uniform Resource Indicator (URI), and
wherein the identified message transport protocol is an SIP.

24. The packet-network telephone of claim 15,
wherein the request message comprises the identifier that identifies the user message and the message transport protocol, and
wherein the identifier identifies the user message and is the request for the user message to be transmitted to the packet-network telephone.
